(19) United States
(12) Patent Application Publication
(10) Pub. No.: US 2016/0120163 A1
(43) Pub. Date: May 5, 2016

(54) Bait Bucket with Self Priming Pump and Venturi

(71) Applicant: Michael P. Arden, Navasota, TX (US)

(72) Inventors: Tim Arden, Dickinson, TX (US); Noel Artuz, Houston, TX (US)

(21) Appl. No.: 14/529,328

(22) Filed: Oct. 31, 2014

(51) Int. Cl. A01K 97/05; A01K 63/04

(52) U.S. Cl. CPC A01K 97/05; A01K 63/042; A01K 63/047

(57) ABSTRACT

A bait bucket having inner and outer buckets with a mating frustoconical shape, or two chamber configuration with void between the two buckets or chambers, a self priming pump disposed in the void between the two buckets operably connected to a power source, the pump connected to a water source for pumping water into the inner bucket, a venturi hose with variable valve connected to the hose for drawing air for aerating the water before entry into the inner bucket, and an adjustable outlet drain in the inner bucket operably connected to a drain pipe that upon the water reaching a pre-determined height exits the inner bucket or chamber through an outlet port. The bait bucket may have external power and LED lights in the inner bucket and draw water through a filter and have external rod holder and a removable lid.

### CROSS REFERENCE TO RELATED APPLICATIONS

Not applicable

### BACKGROUND OF THE INVENTION

1. Field of the Invention

This invention relates to bait buckets, and more particularly to an improved two part bucket with self priming pump and venturi.

2. Description of Related Art

Various prior art patents have attempted to maintain live fish in a bait bucket. U.S. Pat. No. 2,923,087 which discloses a bait bucket 11 having a main container 12 with a removable top lid 13, a flexible water inlet conduit 15 and an outlet conduit 16 connected to a hose 17. A motor 23, energized by a battery assembly 37, rotates a shaft 24 which provides a pumping action that forces water upwardly through inlet conduit 15 and discharges the water into container 12. When the water rises above the level of outlet conduit 16, the excess water overflows through outlet conduit 16 and is discharged by hose 17 as shown in FIG. 2.

U.S. Pat. No. 8,572,889 discloses a bait bucket 10 with aerating and cooling functions. Bait bucket 10 includes an inner bucket 20, a lid 30, an insulated tube 40, an outer bucket 50, an aerating system 25 and a cooling system 14. See FIG. 8.

U.S. Pat. No. 3,904,393 discloses a venturi-type water aerator characterized by a centrifugal pump unit 8 connected to an electric motor 80 by an impeller driving shaft 98. The impeller operates to pump water through a venturi-type fitting 28 which produces aerated water that is discharged via nozzle 38.

Similarly other patents have attempted to illuminate bait buckets with various lighting systems, none of which use LED lights.

None of the prior art teaches or suggest the innovative methods and apparatus described herein. The present invention results in a bait bucket with a venturi for aerating continuously the water and permitting the draw of water from longer distances using a self priming pump that is adaptable to battery power and direct electric power and permits access to the power components.

### SUMMARY OF THE INVENTION

In accordance with a preferred embodiment of the invention there is disclosed a bait bucket having an outer bucket having a frustoconical shape, an inner bucket having a frustoconical shape for stable placement partially within the outer bucket, a self priming pump disposed in a void between the bottom of the inner bucket and the inside bottom of the outer bucket, operably connected to a power source, the pump connected to a hose for access to a water source for pumping water into the inner bucket through a hose displaced in the bottom of the inner bucket, a venturi hose connected to the hose for drawing air from atmosphere an aerating the water before entry into the inner bucket, and an outlet drain in the inner bucket operably connected to a drain pipe that upon the water reaching a pre-determined height enters the drain and exits the inner bucket through an outlet port.

In accordance with another preferred embodiment of the invention there is disclosed a bait bucket having an outer bucket, an inner bucket for stable placement partially within the outer bucket, a self priming pump disposed in a void between the bottom of the inner bucket and the inside bottom of the outer bucket, operably connected to a power source, the pump connected to a hose for access to a water source for pumping water into the inner bucket through a hose operably connected to a port in the bottom of the inner bucket, a venturi hose connected to the hose for drawing air from atmosphere and aerating the water before entry into the inner bucket, and an outlet drain in the inner bucket operably connected to a drain pipe that upon the water reaching a pre-determined height enters the drain and exits the inner bucket through an outlet port.

In accordance with yet another preferred embodiment of the invention there is disclosed a bait bucket having a two chamber vessel having an upper and lower chamber, a self priming pump disposed in the lower chamber below a bottom surface of the upper chamber, the pump operably connected to a power source, the pump connected to a hose for access to a water source for pumping water into the upper chamber through a hose operably connected to the upper chamber, a venturi hose connected to the hose for drawing air from atmosphere and aerating the water before entry into the upper chamber, and an outlet drain in the upper chamber operably connected to a drain pipe that upon the water reaching a pre-determined height enters the drain and exits the upper chamber through an outlet port.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective partial cross sectional view of a bait bucket according to a preferred embodiment of the invention.

FIG. 2 is a side perspective view of a bait bucket according to a preferred embodiment of the invention.

FIG. 3 is a side schematic view of a bait bucket according to a preferred embodiment of the invention.

FIG. 4 is a bottom plan view of an inner bucket of a bait bucket according to a preferred embodiment of the invention.

FIG. 5 is a plan view of the inside bottom of an outer bucket of a bait bucket according to a preferred embodiment of the invention.

FIG. 6 is a top plan view of inner bucket of a bait bucket according to a preferred embodiment of the invention.

FIG. 7 is a side cross sectional view of an inner bucket of a bait bucket according to a preferred embodiment of the invention.

FIG. 8 is a side view of a bait bucket and filter according to a preferred embodiment of the invention.

FIG. 9 is a side view of a bait bucket with rod holder and mesh screen cover according to a preferred embodiment of the invention.

FIG. 10 is a side view of a bait bucket with exposed opening according to a preferred embodiment of the invention.

FIG. 11 is a schematic diagram of circuit for activating power to the pump and lights of a bait bucket according to a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the issued claims and as a representative basis for teaching one skilled in the art to employ the present invention in virtually any appropriately detailed system, structure or manner.

A preferred embodiment of the invention is directed to a fresh or saltwater aerated bait bucket for holding fishing bait. Specifically, the bucket has an approximately 4 inch false bottom, in which a self-priming, pump, a venturi valve, a rechargeable battery and operational wiring, are housed. The self-priming pump has an on/off switch and is connected to the venture valve. When the pump is turned on, water is pulled into the bucket. Air is also pulled through the venturi valve, which causes the air to mix with the water and oxygenate the water. A portion of water inside the bucket overflows and exits through an exit tube and is thereby returned to the water source. The rechargeable battery supplies power to the pump and water-resistant LED lights. Another embodiment employs separate power sources for each of the pump and the LED light system. The bait bucket can be used with both fresh water and saltwater.

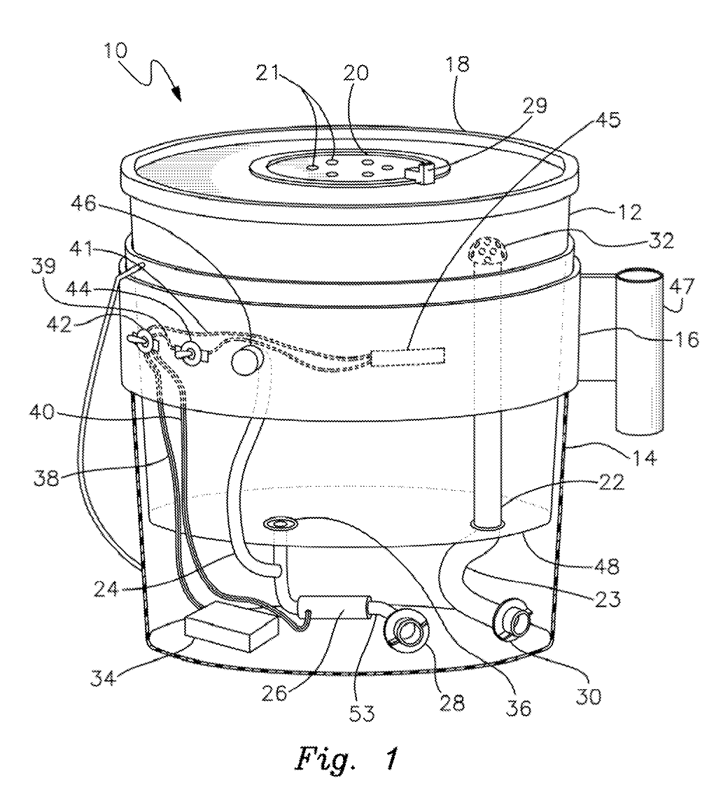

Turning now to FIG. 1, there is shown a bait bucket 10 according to a preferred embodiment of the invention. Bait bucket 10 is comprised of outer bucket 14 and inner bucket 12 that are generally of the same frustoconical shape permitting insertion of inner bucket 12 into outer bucket 14 leaving a space below inner bucket 12 in outer bucket 14. Inner bucket 12 and outer bucket 14 may be of any of a variety of shapes to permit insertion of inner bucket 12 partially into outer bucket 14 and leave a space below inner bucket 12. The shapes may be generally cylindrical of any polygonal shape and may be of different shapes from each other so long as the two can be positioned to create an upper enclosure for water and a space below for placement of a pump and other components. In an alternative embodiment, the inner and outer bucket may be manufactured as one piece using blow molding or other known techniques so long as there is a water holding receptacle or chamber and a lower enclosed chamber for the various components. Alternatively, the upper chamber may be integrated into a bucket using a solid partition to create an upper portion and a lower portion.

Inner bucket 12 has an inlet supply port 36 which is operably connected to self-priming pump 26 that draws water through inlet water port 28 through hose 53 from a source of water. The water may be fresh or salt water. Pump 26 in turn pumps water to inlet supply port 36. Inlet supply port 36 fills inner bucket 12 with water until it reaches a pre-determined height and is drained through drain cap 32. Pump 26 may be of any a variety of self-priming pumps preferably a 12 Volt, 1 Amp self priming water pump with 35 PSI may be used. Pump 26 preferably maintains a constant flow of fresh water into inner bucket 12 at 1.5 gallons per minute and water exits the inner bucket at the same rate and is put back into the environment.

Drain cap 32 is operably connected to standing pipe 22 which is attached to drain hose 23 to outlet port 30 which discharges water. Standing pipe 22 may be removable to facilitate complete drainage of inner bucket 12 through outlet hose 23. It may also be configured in a plurality of sections to permit partial draining of inner bucket 12 when transporting to reduce spillage and weight. For example, if configured in two sections, the upper section may be removed to drain a portion of the water and reduce the overall water content of inner bucket 12.

Operably connected to pump 26 to a hose connected to inlet source 36 is a venturi hose 24 that draws air through venturi valve 46. By turning valve 46 from a closed to a partially open to a fully open position, a variable level of air is introduced to the water as it is pumped into inner bucket 12. This provides aeration to the water which is important to maintaining living fish or other creatures one stores in inner bucket 12. Venturi hose 24 may be alternatively attached to inlet hose 53 before entry to pump 26 for aeration of water being drawn into pump 26 before being pumped into inner bucket 12.

Inner bucket 12 has a frictionally engaged lid 18 which seals the top of inner bucket 12. Lid 18 may alternatively have other engagement mechanisms, including, but not limited to, threaded engagement, brackets, or tighteners known in the art. Positioned in the center of engaged lid 18 is hinged opening 20 which permits access to inner bucket 12 without removal of engaged lid 18. In hinged opening 20 are preferably air holes 21 and a tab 29 for lifting opening 20 about a hinge 25 (not shown) on the opposite side of tab 29.

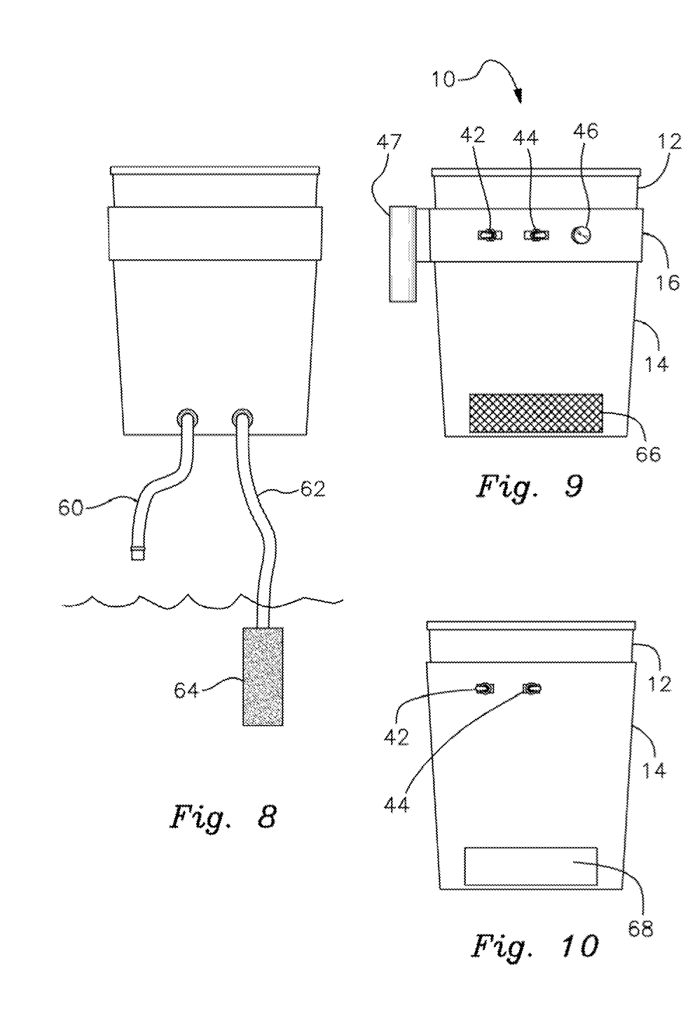

FIG. 1 also shows battery 34 which provides power to pump 26 and LED lights 45. Alternatively, pump 26 may be powered by direct electrical connection to an electrical socket via an adapter not shown. Toggle switch 42 is engaged to battery 34 and pump 26 and toggle switch 44 which is connected to LED lights to regulate electrical power to the two circuits. A retainer 16 is provided that encircles the joining point between inner bucket 12 and outer bucket 14 to cover and seal the area from corrosion or water. Battery 34 may be any of a variety of designs, although in a preferred embodiment is a 12 Volt Gel filled rechargeable 5 Amp battery. Retainer 16 may also have a fishing rod holder 47 mounted integral with the retainer, or by use of a separate bolted on cylindrical tube as shown in FIGS. 1 and 9.

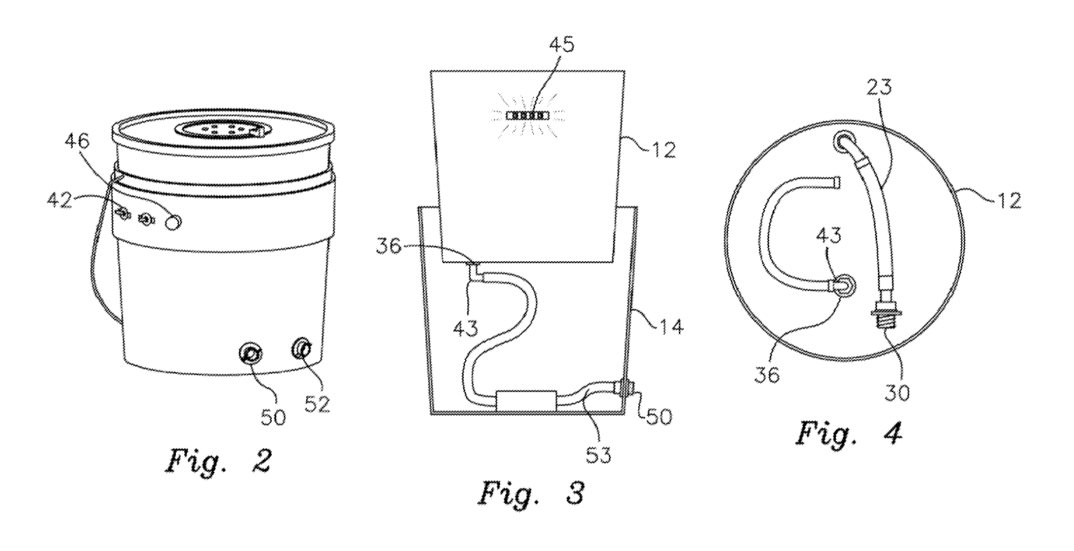

FIG. 2 is a side perspective view of a fully completed bait bucket according to a preferred embodiment of the invention. Switches 42 and 44 are shown next to venturi valve 46. Port adapters 50 and 52 are connected to inlet port 28 and outlet port 30 for operable engagement to extension hoses further described herein. FIG. 3 shows a side schematic view of inner bucket 12 with LED lights 45 around the inside upper surface of inner bucket 12 and shows outer bucket 14 with inlet supply port 36 attached to an L-shaped adapter 43 which in turn is connected to pump 26 and inlet hose 53 and then port adapter 50. FIG. 4 shows a bottom plan view of inner bucket 12 with inlet supply port 36 and outlet hose 23 from drain cap 32 to outlet port 30. FIG. 5 shows a plan view of the inside bottom of outer bucket 14 with pump 26 connected to inlet water port 28 and venturi connector 24 to inlet supply port 36. A partial view of drain hose is shown connected to outlet port 30. Battery 34 is shown with a partial wires going to toggle switch 42 and toggle switch 44. In a preferred embodiment, an additional hose adapter of approximately 5 inches may be used to connect inlet water port 28 to outlet port 30 to close off the ports while transporting bait bucket 10.

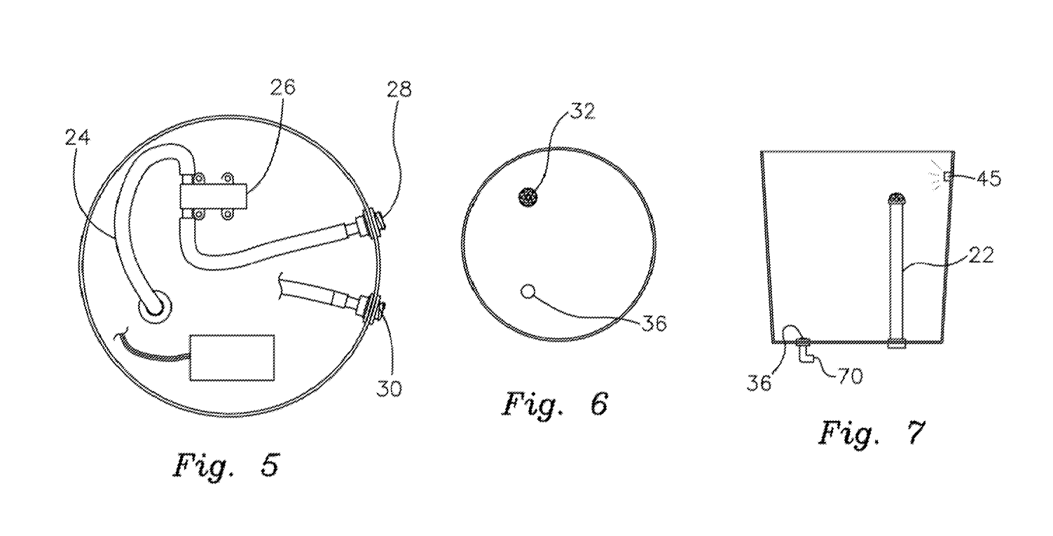

FIG. 6 shows a top plan view of inner bucket 12 with drain cap 32 and inlet supply port 36. FIG. 7 shows a side cross sectional view of inner bucket 12 with standing pipe 22 and inlet supply port 36 connected to adapter 70. Drain pipe 22 may be ½ inch PVC type and adjustable. FIG. 7 also shows LED lights 45 for lighting the inside of inner bucket 12 and may be battery powered or operably connected to battery 34 in the space between inner bucket 12 and outer bucket 14. Preferably, LED lights 45 are water resistant and operate on a 12 Volt source.

FIG. 8 shows an extension hose 60 connected to outlet port 30 (as shown in FIG. 1) and an intake filter 64 connected to inlet hose 62. Intake filter 64 may be ½ inch PVC filter to protect the pump motor and provide a weight to hang the hose into the source of water. Inlet hose 62 may be of any length and by using a self priming pump 26 may be extended from a dock into the ocean water below. Water is drawn from the water source into the bait bucket and aerated as described. FIG. 9 shows a side view of bait bucket 10, with inner bucket 12 and outer bucket 14 connected by retainer 16 which covers wires coming from the battery and pump within outer bucket 14 and provides a base to mount toggle switches 42, 44 and venturi valve 46. Retainer 16 may be of any a variety of materials but preferably it is a 4 inch aluminum wrap that covers the seam of between inner bucket 12 and outer bucket 14. It may also be used to mount the switches and wires to the battery and the pump.

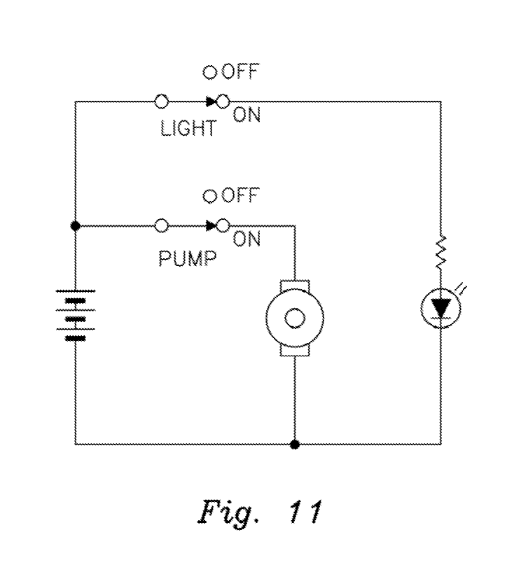

Mesh screen 66 covers an opening in outer bucket 14 to permit an access point to reach the battery, pump and other equipment inside the space below inner bucket 12 as well as to provide a cooling function to permit air flow about the equipment. As shown in FIG. 10, without mesh screen 66, access opening 68 allows access to all of the components within outer bucket 14 for service, replacement and the like.

FIG. 11 shows an electrical schematic of the two circuits of a preferred embodiment of the invention connected to the pump and LED lights with battery power source and on/off switches to activate the pump and lights.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the issued claims.

We claim:

1. A bait bucket comprising:
an outer bucket having a frustoconical shape;
an inner bucket having a frustoconical shape for stable placement partially within said outer bucket;
a self priming pump disposed in a void between the bottom of said inner bucket and the inside bottom of said outer bucket, operably connected to a power source;
said pump connected to a hose for access to a water source for pumping water into said inner bucket through a hose displaced in the bottom of said inner bucket;
a venturi hose connected to said hose for drawing air from atmosphere an aerating said water before entry into said inner bucket; and
an outlet drain in said inner bucket operably connected to a drain pipe that upon said water reaching a pre-determined height enters said drain and exits said inner bucket through an outlet port.

2. The bait bucket of claim 1 further comprising LED lights disposed about the inside periphery of said inner bucket above said drain.

3. The bait bucket of claim 1 further comprising a battery for supplying power to said pump.

4. The bait bucket of claim 1 further comprising a mushroom shaped cap with holes about its periphery for entry of water to said drain.

5. The bait bucket of claim 1 further comprising a valve operably connected to said venturi tube to access the atmosphere.

6. A bait bucket comprising:
an outer bucket;
an inner bucket for stable placement partially within said outer bucket,
a self priming pump disposed in a void between the bottom of said inner bucket and the inside bottom of said outer bucket, operably connected to a power source;
said pump connected to a hose for access to a water source for pumping water into said inner bucket through a hose operably connected to a port in the bottom of said inner bucket;
a venturi hose connected to said hose for drawing air from atmosphere and aerating said water before entry into said inner bucket; and
an outlet drain in said inner bucket operably connected to a drain pipe that upon said water reaching a pre-determined height enters said drain and exits said inner bucket through an outlet port.

7. The bait bucket of claim 6 further comprising a toggle switch operably connected to said power source.

8. The bait bucket of claim 6 further comprising an access window in said outer bucket lower side.

9. The bait bucket of claim 8 wherein said access window is covered with a mesh screen.

10. The bait bucket of claim 6 wherein said drain pipe is rigid.

11. The bait bucket of claim 6 further comprising a removable lid on said inner bucket.

12. The bait bucket of claim 11 wherein said lid comprises a hinged opening.

13. The bait bucket of claim 6 further comprising lights disposed on the inside of said inner bucket.

14. A bait bucket comprising:
a two chamber vessel having an upper and lower chamber;
a self priming pump disposed in said lower chamber below a bottom surface of said upper chamber, said pump operably connected to a power source;
said pump connected to a hose for access to a water source for pumping water into said upper chamber through a hose operably connected to said upper chamber;
a venturi hose connected to said hose for drawing air from atmosphere and aerating said water before entry into said upper chamber; and
an outlet drain in said upper chamber operably connected to a drain pipe that upon said water reaching a pre-determined height enters said drain and exits said upper chamber through an outlet port.

15. The bait bucket as claimed in claim 14 further comprising a battery.

16. The bait bucket as claimed in claim 14 further comprising lights in said upper chamber.

17. The bait bucket as claimed in claim 14 further comprising a lid on said upper chamber.

18. The bait bucket as claimed in claim 14 further comprising a filter operably connected to said hose for access to a water source.

19. The bait bucket as claimed in claim 14 further comprising a valve operably connected to said venturi hose.

20. The bait bucket as claimed in claim 14 further comprising a hinged lid.
